(19) United States
(12) Patent Application Publication
(10) Pub. No.: US 2025/0280844 A1
(43) Pub. Date: Sep. 11, 2025

(54) FOOD PRESERVING COATINGS

(71) Applicant: Sio Valley Technologies, Inc., Wilmington, DE (US)

(72) Inventor: Jean Paul Nageri, Kampala (UG)

(21) Appl. No.: 18/600,409

(22) Filed: Mar. 8, 2024

(51) Int. Cl. A23B 7/16; A23B 7/154

(52) U.S. Cl. CPC A23B 7/16; A23B 7/154

(57) ABSTRACT

Embodiments of the inventive subject matter are directed to creating and applying a food preserving coating that contains a diglyceride, an acetyl triglyceride, an emulsifier, an antiseptic, and water. The coating can be applied by submersion or spray, and it forms a thin, transparent, and firm peel on a food surface. Coatings described in this application improve shelf life of foods they are applied to and are particularly useful in helping to prolong the shelf life of fresh produce.

### FIELD OF THE INVENTION

The field of the invention is food preserving coatings.

### BACKGROUND

The background description includes information that may be useful in understanding the present invention. It is not an admission that any of the information provided in this application is prior art or relevant to the presently claimed invention, or that any publication specifically or implicitly referenced is prior art.

Sucrose ester and fatty acid coatings have been recognized for their ability to extend shelf life of produce. But critical limitations inherent to these technologies necessitate further innovation. Notably, such coatings exhibit restricted gas barrier properties, adversely affecting the gaseous exchange essential for maintaining produce freshness during packaging. This deficiency compromises the moisture and gas barrier efficacy required for optimal preservation. These coatings also exhibit inadequate moisture retention capabilities, leading to diminished firmness and textural degradation of treated produce. This phenomenon underscores the need for advancements in coating formulations to ensure the preservation of moisture levels that is critical for sustaining the freshness, texture, and overall quality of fruits and vegetables. These identified shortcomings serve as a foundational premise for the development of a novel coating solution, aimed at addressing these barriers to prolong the shelf life and maintain the quality of perishable goods more effectively. See, e.g., Krishna Priya, Nirmal Thirunavookarasu, D. V. Chidanand. (2023). Recent advances in edible coating of food products and its legislations: A review. Journal of Agriculture and Food Research, 12, 100623.

Findings in Sapper, M., & Chiralt, A. (2018). Starch-Based Coatings for Preservation of Fruits and Vegetables. Coatings, 8(152) hold particular relevance. Within the framework of formulating gas-permeable coatings for this application, it becomes imperative to meticulously assess the constraints associated with various materials, including those predicated upon starch. While starch exhibits favorable attributes such as widespread availability, cost efficiency, and commendable film-forming characteristics, it is susceptible to moisture and other potential issues arising from its constrained water vapor barrier properties and mechanical durability.

Using calcium salts for maintaining the quality of fresh fruits and vegetables presents both promise and challenges. Notably, research has revealed several limitations in this approach. Despite the potential for calcium to bolster cell wall integrity, it may not consistently prevent texture changes, microbial growth, or biochemical alterations in treated produce. Factors such as produce type, storage conditions, and initial quality further influence the efficacy of calcium salt treatments, leading to variable shelf-life extensions. Moreover, concerns arise regarding potential impacts on sensory attributes (taste, appearance, smell, and so on), which may affect consumer acceptance. These findings underscore the necessity for continued research to refine treatment protocols and address the multifaceted challenges associated with preserving fresh produce using calcium salts, ultimately enhancing product quality throughout storage and distribution. See, e.g., Martin-Diana, A. B., Rico, D., Frias, J. M., Barat, J. M., Henehan, G. T. M., Barry-Ryan, C. (2007). Calcium for extending the shelf life of fresh whole and minimally processed fruits and vegetables: a review. Trends in Food Science & Technology, 18(4), 210-218.

In some cases, a long shelf life for vegetables and other fruit in permanent storage can be achieved by using paraffin emulsions. As discussed in Khalid, M. A., Niaz, B., Saeed, F., Afzaal, M., Islam, F., Hussain, M., Hafiz, M., Khalid, M. S., Siddeeg, A., & Al-Farga, A. (2022), while paraffin wax coatings are known for their moisture barrier properties enhancing the safety and quality attributes of fresh produce with effectiveness depending on the wax solution's consistency and storage temperature, regulatory and safety concerns limit their application. International Journal of Edible coatings for enhancing safety and quality attributes of fresh produce: A comprehensive review. International Journal of Food Properties, 25(1), 1817-1847. This underscores the necessity for developing new edible coating solutions that address these limitations.

Using synthetic waxes coupled with conventional chemical fungicides has been a standard approach to mitigate postharvest losses, attributed largely to decay, weight loss, and physiological disorders. Despite their effectiveness in prolonging shelf life, these methods have engendered significant health and environmental concerns. Notably, the production of chemical residues and the emergence of resistant pathogenic fungal strains present critical challenges, underscoring the pressing need for innovative, eco-friendly alternatives in postharvest preservation strategies. Palou, L. and Pérez-Gago, M. B. (2021). Antifungal edible coatings for postharvest preservation of fresh fruit. Acta Hortic. 1325, 127-140.

High pressure and decompression technology offers innovative way to extend shelf life and inhibit microbial activity without freezing at sub-zero temperatures. Fang, Y., & Wakisaka, M. (2021). A Review on the Modified Atmosphere Preservation of Fruits and Vegetables with Cutting-Edge Technologies. Agriculture, 11(10), [Article 992]. Yet, the technology confronts substantial barriers, notably economic costs, technical complexities, and potential compromises to the structural integrity of fruits and vegetables. These challenges restrict the broader application of such technologies in the preservation sector, indicating a pivotal area for further innovation and research to make these methods more accessible and applicable across various types of produce.

Using organic preparations such as iodine in connection with gel-forming substances, to increase the shelf life of fruits and vegetables comes with detrimental side effects such as a propensity to cause undesirable health outcomes and symptoms. As derived from the document by Borbor Suarez (2022), underscores the necessity for innovation in the preservation of fresh-cut fruits and vegetables, especially given the limitations of current chemical preservation methods. Borbor Suarez, D. (2022). Tecnologia aplicada en las frutas y hortalizas de cuarta gama y su influencia en el uso del material de empaque [Technology applied to fresh-cut fruits and vegetables and its influence on the use of packaging material]. Universidad Agraria del Ecuador, Centrosur & Instituto Superior Edwards Deming. Vol. 1, No. 13. ISSN-e: 2706-6800. These methods' challenges-such as corrosiveness, pH-dependency, and the emanation of toxic volatiles-necessitate safer, more efficient alternatives.

Finally using solutions that incorporate polyvinyl compounds and antiseptics to treat fruits and vegetables represents a paradigm shift toward more sustainable and efficient food preservation techniques. It stands at the confluence of cost-efficiency and enhanced preservative efficacy, challenging the traditional reliance on shellac-based coatings. Shit, S. C., Shah, P. M., & Saiter, J.-M. (2014). Edible Polymers: Challenges and Opportunities. Journal of Polymers, 2014, Article 427259. But the transition to synthetic coatings such as polyvinyl acetate is not without its hurdles. Critical among these are the necessity for consumer acceptance of synthetic materials in food preservation, the delicate balance required to maintain the sensory qualities of produce, and the rigorous adherence to food safety regulations. These factors are not merely operational challenges but pivotal considerations that underscore the ongoing need for research and development.

These and all other extrinsic materials discussed in this application are incorporated by reference in their entirety. Where a definition or use of a term in an incorporated reference is inconsistent or contrary to the definition of that term provided in this application, the definition of that term provided in this application applies and the definition of that term in the reference does not apply.

Thus, there still exists a need in the art for improved formulations for substances that can improve the shelf life of foods, such as fresh produce.

### SUMMARY OF THE INVENTION

The present invention is directed to systems, formulations, and methods relating to food preserving coatings. In one aspect of the inventive subject matter, a food preserving coating formulation comprises: a diglyceride; an acetyl triacylglycerol; an emulsifier; an antiseptic; and water.

The diglyceride can include at least one of a palmitic acid, a stearic acid, and oleic acid, and a linoleic acid. In some embodiments, the antiseptic comprises a byproduct of a member of the genus Allium. The antiseptic can therefore be made from a garlic. The acetyl triacylglycerol can be an oil derived from at least one of a Gymnosporia senegalensis plant, a Loeseneriella africana plant, Mystroxylon aethiopicum, and a Cassine burkeana plant. In some embodiments, the acetyl triacylglycerol is an oil derived from at least one of a plant belonging to the Celastraceae family.

In some embodiments, the diglyceride has a concentration relative to non-water ingredients in a range of 19-30%, the acetyl triacylglycerole can have a concentration relative to non-water ingredients of 40-65%, the emulsifier can have a concentration relative to non-water ingredients of 14-35%, and the water can have a concentration of 70-97%.

In another aspect of the inventive subject matter, a food preserving coating formulation comprises: a diglyceride; an acetyl triacylglycerol comprising a plant oil; an emulsifier comprising at least one of a lactyl diglyceride salt and a succinylated diglyceride salt; an antiseptic comprising a garlic byproduct; and water.

In some embodiments, the diglyceride comprises at least one of a palmitic acid, a stearic acid, and oleic acid, and a linoleic acid. In some embodiments, the plant oil comprises at least one of a Gymnosporia senegalensis plant, a Loeseneriella africana plant, Mystroxylon aethiopicum, and a Cassine burkeana plant. The acetyl triacylglycerol can be an oil derived from at least one of a plant belonging to the Celastraceae family.

In some embodiments, the diglyceride has a concentration relative to non-water ingredients in a range of 19-30%, the acetyl triacylglycerole can have a concentration relative to non-water ingredients of 40-65%, the emulsifier can have a concentration relative to non-water ingredients of 14-35%, and the water can have a concentration of 70-97%.

One should appreciate that the disclosed subject matter provides many advantageous technical effects including food preserving formulations that leverage native plant life to create inexpensive, highly effective coatings that improve shelf life of fresh produce and other foods.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 shows the general chemical structure of 1,2-diacylglycerols.

FIG. 2 shows the general chemical structure of 1,3-diacylglycerols, where R1 and R2 in both figures are fatty acid side chains.

FIG. 3 shows the chemical structure of a triglyceride fatty acid, where R is a fatty acid residue.

FIG. 4 is a flowchart describing generally how a coating of the inventive subject matter is used.

FIG. 5 is a flowchart describing how a coating of the inventive subject matter can be created.

FIG. 6 is a flowchart demonstrating flexibility in how an antiseptic can be incorporated into a coating of the inventive subject matter.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

Improving the shelf life of fresh produce presents a significant challenge. Demand for produce is constantly increasing, and with that demand comes a need to improve produce shelf life while also preserving its nutritional content. Embodiments of the inventive subject matter address both these issues by helping to preserve fresh produce while also maintaining its nutritional content. Embodiments of the inventive subject matter are thus directed to coatings that can be applied to food to improve its shelf life. Coatings of the inventive subject matter are used to improve the shelf life of foods such as fresh fruits and vegetables.

Coatings of the inventive subject matter prolong the shelf life of foods like fruits and vegetables. Coatings described in this application outperform existing coatings by up to three months under certain conditions. Coatings disclosed in this application contain no harmful chemicals or substances, while other existing food preserving substances often contain harmful substances such as fungicides and antibiotics. All ingredients that go into coatings disclosed in this application are known, commercially available and inexpensive. In addition, they can be sourced from plants that are widely available and indigenous to different parts of the world, including in parts of Africa where food preserving coatings are in high demand.

Foods like fresh fruits and vegetables that would benefit from long term storage can be treated with coatings of the inventive subject matter by various methods. In some embodiments, foods can be submerged into a coating for some duration of time before being removed and dried, while in some other embodiments, foods can be sprayed with an atomized coating before drying. As a result, a thin, transparent peel of a coating is formed on the surface of the target foods. The coating, once applied and dried, protects foods against drying and rotting during long term storage. Coatings of the inventive subject matter are generally not visually noticeable and can be easily rinsed off. The invention thus offers several advantages, such as improving the shelf life of foods by up to three months, preserving the nutritional content of foods, using natural and inexpensive ingredients, and being easily removable by water.

Thus, embodiments of the inventive subject matter are mixtures having ingredients that, together, can be used to create a substance that can be applied to fresh produce as a coating (e.g., by submersion, by spray coating, and so on). Table 1 gives ingredients concentrations (expressed in mass percents) for ingredients that can be used to create example coatings of the inventive subject matter with both high and low water dilutions. Ingredients include a diglyceride, an acetyl triglyceride, an emulsifier, an antiseptic, and water. The examples shown in Table 1 include different amounts of water and are thus diluted to different degrees.

TABLE 1

| | Concentration, | Concentration, |
|---|---|---|
| Ingredient | high dilution | low dilution |
| Diglyceride | 0.80% | 6.4% |
| Acetyl triacylglycerol | 1.70% | 13.3% |
| Emulsifier | 0.05% | 0.4% |
| Antiseptic | 0.50% | 6.6% |
| Water | 96.95% | 73.30% |

Table 2 shows ingredient concentrations relative to all non-water ingredients for the two coatings disclosed in Table 1. This table therefore demonstrates that each of the ingredients of a coating of the inventive subject matter can feature some variety in amount that is included. Based on a formulation that features 96.95% water by mass, a diglyceride is 26.2% of the non-water ingredients, an acetyl triacylglycerol is 55.7%, an emulsifier is 1.6%, and an antiseptic is 16.4%. Based on a formulation that features 73.3% water by mass, a diglyceride is 24% of the non-water ingredients, an acetyl triacylglycerol is 49.8%, an emulsifier is 1.5%, and an antiseptic is 24.7%. Thus, the first column of Table 1 corresponds to the first column of Table 2, and the second column of Table 1 corresponds to the second column of Table 2.

TABLE 2

| | Concentration | Concentration |
|---|---|---|
| | w/o water, | w/o water, low |
| Ingredient | high dilution | dilution |
| Diglyceride | 26.2% | 24.0% |
| Acetyl triacylglycerol | 55.7% | 49.8% |
| Emulsifier | 1.6% | 1.5% |
| Antiseptic | 16.4% | 24.7% |

Table 2 therefore discloses a range of ingredient concentrations expressed as a percent of each ingredient to the sum of all ingredients without water, where the “low end” column relates to a mixture that is diluted with 96.95% water and the “high end” column relates to a mixture that is diluted with 73.30% water (according to Table 1, above). Ranges for each individual ingredient's concentration is therefore derived from the formulations disclosed in Table 1.

The ranges that are inherent in Table 2 demonstrate that each ingredient can fall within an acceptable range of concentrations without deviating from the inventive subject matter. Table 3 discloses these acceptable possible ranges, where the total must always add up to 100% with each other ingredient falling within its own disclosed acceptable range.

TABLE 3

| Ingredient | Range |
|---|---|
| Diglyceride | 19-30% |
| Acetyl triacylglycerol | 40-65% |
| Emulsifier | 1-3% |
| Antiseptic | 14-35% |

Because each coating of the inventive subject matter can only have ingredient concentrations that add up to 100%, if, for example, acetyl triacylglycerol is selected to be at a 65% concentration, then at least one other ingredient cannot be at its top end range. But as long as each other ingredient falls within a range disclosed in Table 3, the coating will be operable for its intended purpose.

Embodiments can thus be created as a concentration, where, for example, mixtures having ingredient concentrations described in Table 2 are created without any water (or other diluting agent). Once a mixture is created, water can then be added after the fact to create a coating of the inventive subject matter. Emulsifiers in the mixture allow it to be mixed with water. Concentrated mixtures can be useful because they reduce the amount of a mixture that needs to be transported (by reducing both mass and volume), which reduces transportation costs while increasing how much can be transported in a shipment. Water can be added later to create a coating that can be applied to foods.

Although some precise concentrations of water are disclosed in Table 1 (and an implied range exists between those two endpoints), it should be understood that the concentration of water in a given coating of the inventive subject matter can range from about 70% to about 97%. As described above, coatings can comprise water in an amount ranging from about 73.3% to about 96.95% by weight of the total composition. These values are provided for the purpose of illustration and depending on specific application requirements or variations in formulation parameters, minor deviations outside of this specified range remain within the scope of the invention. Specifically, a lower threshold from about 70% was arrived at based on a minimum amount of water needed in a coating to achieve desired properties such as adhesion, flexibility, and durability of the coating, while an upper limit of about 97% is established to ensure the coating retains sufficient viscosity and structural integrity upon application. It should be understood that concentrations slightly below 73.3% or slightly above 96.95% may still be functional for some embodiments of the invention, provided that such deviations do not materially affect the overall performance characteristics of the coating. Variations in water concentration can be introduced to account for, e.g., environmental factors, application techniques, or substrate properties, thereby creating flexibility in the formulation while still falling within the ambit of the inventive concepts disclosed in this application. Within disclosed ranges, an amount of water in a given coating can also be guided by economic decisions, such as water availability and price.

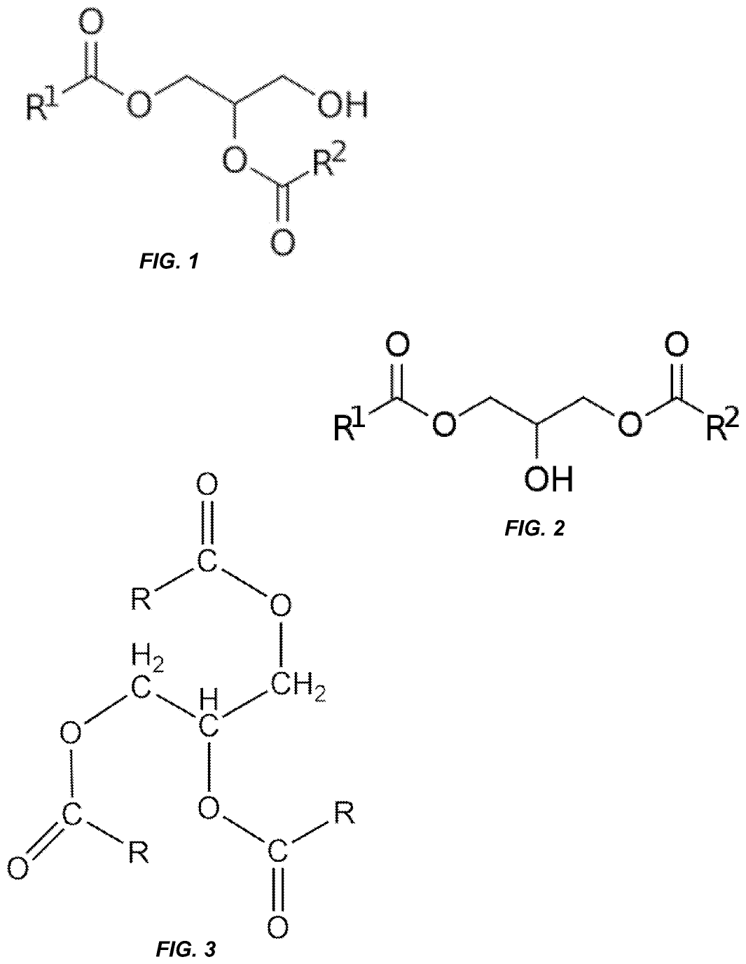

Concentrated mixtures of the inventive subject matter thus include a diglyceride, an acetyl triacylglycerol, an emulsifier, and an antiseptic. A diglyceride (or diacylglycerol, abbreviated as DAG) consists of two fatty acid chains covalently bonded to a glycerol molecule through ester linkages. There are two possible forms of diglycerides: 1,2-diacylglycerols and 1,3-diacylglycerols. Diglycerides are natural components of food fats, although they are minor compared to triglycerides. When combined with monoglycerides (e.g., E471, which refers to mono- and diglycerides of fatty acids), they form a common food additive used to improve texture and prevent separation in products like baked goods, ice cream, peanut butter, and margarine. FIG. 1 shows the general chemical structure of 1,2-diacylglycerols, and FIG. 2 shows the general chemical structure of 1,3-diacylglycerols, where R1 and R2 in both figures are fatty acid side chains.

Embodiments use a meticulously curated assortment of diglycerides, specifically 1-Palmitoyl-2-oleoyl-glycerol (POG), 1-Stearoyl-2-linoleoyl-glycerol (SLG), 1-Oleoyl-2-palmitoyl-glycerol (OPG), and 1,2-Dilinoleoyl-sn-glycerol (DLG), derived from traditional plant sources for the innovative development of edible coatings of the inventive subject matter. Diglycerides used in coatings can be sourced from a diverse array of traditional plant oils, including but not limited to palm, soybean, olive, and linseed oils, which are known for their high concentrations of palmitic, stearic, oleic, and linoleic acids, all of which improve performance of coatings of the inventive subject matter. Strategically selecting and processing these plant-based oils into specific diglycerides is an important part of achieving the intended functionality of the edible coatings.

When applied to fresh produce, these diglycerides create a protective, semi-permeable coating that meticulously modulates moisture loss and gas exchange, significantly extending the shelf life of fruits and vegetables by slowing down natural degradation processes. Coatings imbued with POG, SLG, OPG, and DLG further exhibit pronounced antimicrobial and antioxidative properties, effectively minimizing microbial spoilage and oxidative deterioration. This dual action not only preserves the nutritional and organoleptic quality of produce but also enhances its marketability through the maintenance of visual appeal and textural integrity. Advantages enjoyed by coatings of the inventive subject matter that use these diglycerides include not only functional benefits (increased shelf life of stored foods, etc.) but also a sustainable approach to sourcing from traditional plant sources that embodies that respects ecological balance, supports traditional agricultural practices, and promotes the well-being of communities involved in the cultivation and processing of these plant oils. Through this invention, the utility of plant-derived diglycerides in extending the freshness and viability of perishable foods is realized, showcasing a scalable, environmentally friendly strategy for enhancing food security and reducing waste. Embodiments of the inventive subject matter demonstrate how plant-derived diglycerides can be used to prolong the shelf life and quality of perishable foods, offering a sustainable, eco-friendly approach for improving food security and reducing waste.

Acetyl triglyceride can be obtained as an oil from the seeds of a variety of plants, including in the seeds of plants belonging to the Celastraceae family, which include, e.g., Gymnosporia senegalensis, Loeseneriella africana, Mystroxylon aethiopicum, and Cassine burkeana. Celastraceae, also known as the staff-vine or bittersweet family, is a family of plants that includes about 98 genera and 1,350 species. These species range from herbs and vines to shrubs and small trees, and they belong to the order Celastrales.

The majority of the genera in this family are tropical, with only a few like Celastrus (the staff vines), Euonymus (the spindles), and Maytenus being widespread in temperate climates. Celastraceae plants is native to both tropical and temperate zones.

Triacylglycerols, also known as triglycerides or TAGs, are esters derived from glycerol and three fatty acids. They are essential for long-term energy storage as well as for insulation and protection. Triacylglycerols can be ingested directly or synthesized from extra dietary protein or carbohydrates. FIG. 3 shows the chemical structure of a triglyceride fatty acid, where R is a fatty acid residue. Finally, in chemistry, acetylation is an organic esterification reaction with acetic acid. It introduces an acetyl group into a chemical compound. Such compounds are termed acetate esters or simply acetates. In mixtures of the inventive subject matter, an acetyl triglyceride is therefore a triacylglycerol that has been subject to acetylation.

An emulsifier is a substance that helps mix two or more liquids that are usually not mixable. In an emulsion, one liquid is dispersed in the other. For example, water and oil do not usually mix, but emulsifiers help mix them. Emulsifiers are commonly used in food products. For example, they are often added to processed foods like mayonnaise, ice cream, chocolates, peanut butter, cookies, creamy sauces, margarine, and baked goods to prevent the separation of their oil and water components. Emulsifiers also give these foods a smooth texture and increase their shelf life.

Emulsifiers work by containing two phases—a dispersed phase and a continuous phase. The continuous phase in the emulsion typically holds the dispersed phase. In an oil-in-water emulsion, water is the continuous phase, and oil is the dispersed phase. In a water-in-oil emulsion, the continuous phase is oil. Emulsifiers make both types of emulsions.

In embodiments of the inventive subject matter, two emulsifiers are contemplated: a lactyl diglyceride salt and a succinylated diglyceride salt. Lactyl diglycerides, also known as lactic acid esters of mono and diglycerides (LACETEM or E472b), are a type of emulsifier commonly used in food products. The IUPAC name for lactyl diglycerides is (2R)-2,3-dihydroxypropyl (2R)-2-hydroxypropanoate. A lactyl diglyceride salt is a product of a reaction between a base of an alkali metal with diglyceride and lactic acid esters.

In the field of food product formulation, use of lactylated and succinylated diglycerides in salt forms presents a sophisticated approach to enhancing product stability, texture, and shelf-life, predicated on their inherent chemical structure and functional properties. These salt forms exhibit superior water solubility, thereby facilitating their integration into diverse food matrices and ensuring uniform distribution, which is pivotal for consistency and longevity of a product. Introducing ionic groups into these molecules significantly augments their emulsifying capabilities, enabling more effective reduction of surface tension between immiscible phases, such as oil and water, and thus stabilizing emulsions. Moreover, their capacity to stabilize pH and act as buffering agents is essential for maintaining quality and safety of food products. Adaptability of these emulsifiers is further evidenced by their ability to modify their chemical structure for tailored functionality-influenced by the choice of cation in the salt-impacting melting points, flavor profiles, and interactions with other ingredients. Additionally, selecting specific emulsifier salts is often guided by regulatory and labeling considerations, allowing food manufacturers to navigate complex regulatory landscapes in different jurisdictions to meet consumer and governmental labeling needs and demands.

A succinylated diglyceride is a type of diglyceride molecule containing a succinylated acid moiety. Its IUPAC name is (2R)-2,3-bis[(2R)-2-hydroxypropanoyloxy]butanedioic acid. In food science and the food industry, diglycerides, including succinylated diglyceride (E472g or SMG), are frequently used as emulsifiers, stabilizers, and thickeners. These emulsifiers play a role in improving the texture, consistency, and shelf life of food products by enhancing stability and preventing ingredient separation. Succinylated diglyceride may find applications in a wide range of processed foods such as baked goods, margarine, dairy products, and salad dressings and are thus ingestible. A succinylated diglyceride salt is a product of a reaction between a base with an alkali metal, for example magnesium oxide or alkaline earth metal with diglyceride and succinylated acid esters.

For a concentrated mixture of the inventive subject matter to be able to mix with water to create a coating, a range of 0.05-0.4 percent mass of a lactyl diglyceride salt or 0.05 to 0.4 percent mass of a succinylated diglyceride salt can be used as an emulsifier, as disclosed in Table 1. In some embodiments, a combination of both can be used such that the total of both possible emulsifiers falls within the disclosed mass percent range. At least one of these emulsifiers must be present in the formulation; otherwise, a mixture made using the ingredients disclosed in this application will not mix with water to create a coating.

Finally, an antiseptic is included, unlike antibiotics, which destroy bacteria within the body, antiseptics are antimicrobial substances that are specifically applied to living tissue or skin of an organism or food product. Embodiments of the inventive subject matter can include antiseptics such as those made from onions, garlic, and the like. When an antiseptic of the inventive subject matter is said to be made from a particular plant or product, it should be understood that it means the antiseptic uses all of or some byproduct of that plant or product. Other ingredients can be included as needed to create a suitable antiseptic.

Onions, garlic, and other members of the genus Allium possess natural properties that contribute to their antiseptic qualities. The following discussion uses onions as a primary example, though other Allium species have similar qualities. Onions are rich in sulfur compounds, which exhibit antibacterial qualities. Cutting an onion triggers the release of enzymes. These enzymes initiate a chemical reaction, producing propenesulfenic acid. Eventually, this acid decomposes to yield sulfuric acid, which has antiseptic qualities. In coatings of the inventive subject matter, sulfur content and enzymatic reactions that members of the genus Allium are known for contribute antiseptic qualities, thus improving shelf life of produce that such coatings are applied to.

Other antiseptics can be used, as well, such as ethyl alcohol, acetic acid, lactic acid or other antiseptics that are commonly used in the food industry. Examples of antiseptics that can be used in embodiments of the inventive subject matter can include, for example, blackjack (Bidens pilosa), onion, pepper, mustard (Sinapisalba), horseradish (Armoracia), caraway (Carum carvi), anise (Pimpinella anisum) and other suitable nutritional antiseptics. In preferred embodiments, preferably blackjack or radish can be used, since both impart adequate antiseptic properties give the mixture effective antiseptic properties.

All ingredients together without water can be mixed to create a concentrated mixture that can then be diluted with water to create a coating of the inventive subject matter. Thus, to create a coating of the inventive subject matter, diglyceride, acetyl triglyceride and an emulsifier comprising one or both of a succinylated diglyceride salt and a lactylated diglyceride salt are mixed in concentrations within the disclosed ranges and then heated until the mixture melts. The melted mixture is added to water and mixed intensively at a temperature of, e.g., 45 to 55° C. until an emulsion is obtained. An antiseptic is also stirred into the emulsion. The antiseptic can be added before water is added, or it can be added after water is added.

Combining all ingredients with water results in an emulsion in which the diglycerides are in a suspended state. Because diglyceride and acetylated triglyceride are lipophilic substances, they become stable in water through the presence of an emulsifier such as a succinylated triglyceride salt, a lactylated diglyceride salt, or some combination thereof. The selected emulsifier allows the creation of a colloidal solution in water in which there is dispersion and stabilization of the lipophilic substances. The result is a coating of the inventive subject matter that does not have a smell or taste, and its appearance is similar to that of milk.

Once a coating of the inventive subject matter has been created using the ingredients described above, it can be used on food such as fruits and vegetables. To apply the coating to food, the target food can be submerged into the coating, or the coating can be applied via spray. If using a submersion technique, foods should be fully submerged into the coating so as to completely cover all exterior surfaces. Foods should remain submerged for a duration of time ranging from several seconds to several minutes. In some embodiments, foods are submerged anywhere from 1 second to 5 minutes. Mixing an emulsion for longer than the maximum recommended time of 5 minutes can lead to over-processing. Excessive mixing might break down an emulsion's structure, resulting in separation or an undesirable change in texture and consistency. Overmixing can also introduce air bubbles, affecting a coating's stability and appearance.

After a submerged food is removed from the coating, excess coating is allowed to drain off and any coating that remains on the food is allowed to dry. The drying process can involve passively allowing foods to rest until naturally dried or by actively drying by, e.g., blowing air across the coated food.

Another method of applying a coating of the inventive subject matter to foods is by spray. By loading a sprayer with a coating mixture, the sprayer can apply the coating to the exterior surfaces of foods. Spray coating can be more efficient that submersion coating in some circumstances, as it may use less coating per food product. In embodiments that use submersion to fully coat food products, detritus from those foods can contaminate the coating that the foods are submerged into, which can result in wasted coating. Spray coating techniques do not give rise to this issue.

Once coating applied to a food has dried, the result is a food having a thin, transparent, and firm coating on its surface. This coating protects, e.g., fruits, berries, and vegetables against drying and spoiling during long-term storage, and it reduces exchanges of gas between the air and the food to improve the food's shelf life. The protective coating is generally not visually detectable, and it does not change the shape or flavor of the food it is applied to.

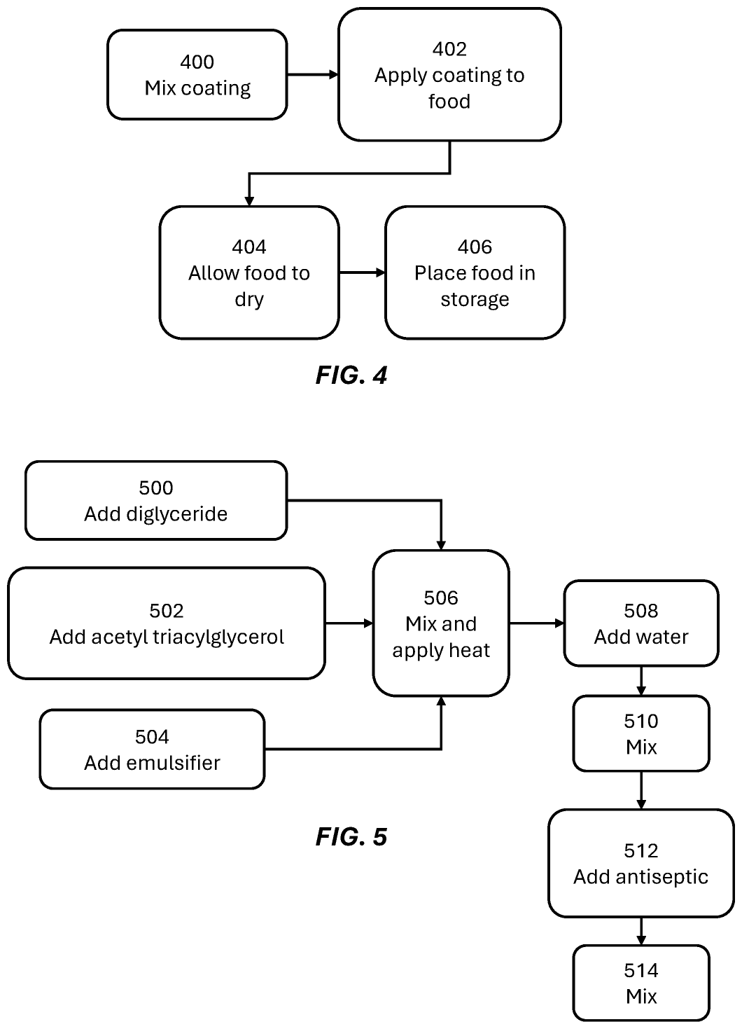

FIG. 4 is a flowchart describing generally how a coating of the inventive subject matter is used. First, a coating is mixed in step 400. This process is described in more detail in FIG. 5 as well as in the examples below. Next, in step 402 the coating is applied to food. Once applied to food, the coating is allowed to dry per step 404. Finally, in step 406, the food can be placed into storage. Examples of how coatings of the inventive subject matter can be applied to foods are described elsewhere in this application.

Mixing a coating of the inventive subject matter can be carried out according to the flowchart in FIG. 5. In steps 500, 502, and 504, at least three ingredients are added to a mixing container: a diglyceride 500, an acetyl triacylglycerol 502, and an emulsifier 504. Once these ingredients are combined, heat is applied and the mixing is carried out according to step 506. Mixing can take place with a mixing apparatus operating at 700-800 RPM, and only as much heat as is necessary to ensure the mixture is liquid is applied, because once a mixture of these ingredients is liquid it can be mixed more easily. Once these ingredients have been mixed, water can be added. Because an emulsifier exists in the mixture, water can be added per step 508. In step 510, the water is mixed in to create an emulsion. Once the emulsion is created, then in step 512 water is added to create a coating of the inventive subject matter. That coating can then be applied to foods according to, e.g., the flowchart in FIG. 4. This process of mixing a coating of the inventive subject matter can be implemented for all embodiments described in this application.

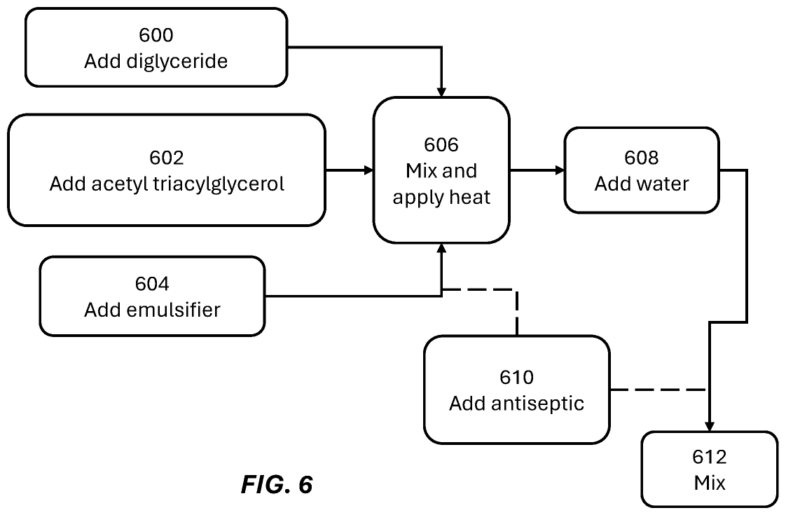

FIG. 6 is a flowchart demonstrating flexibility in adding the antiseptic ingredient. In step 600, a diglyceride is added, in step 602, an acetyl triacylglycerol is added, and in step 604, an emulsifier is added. At this stage, an antiseptic can be added according to step 610. Next, the ingredients are heated and mixed according to step 606. In step 608, water is added to the mixture. At the same time, if an antiseptic was not added already, an antiseptic can be added with the water according to step 610 and then mixing can occur per step 612. There is thus flexibility in when the antiseptic is added, and although, for example, FIG. 6 shows the antiseptic and water being added and mixed at the same time, it should be understood that water can be added, then mixed, and then antiseptic can be added and again mixed without deviating from the inventive subject matter.

Some advantages conferred by coatings of the inventive subject matter include that they give rise to protective properties to the foods they coat, they are harmless when ingested, and they are easily rinsed off with water. Thus, if necessary, a coating can be removed quickly and without difficulty by washing foods such as fruits, berries, and vegetables with water.

To better illustrate how coatings of the inventive subject matter can be created and used, several real-world examples follow.

### Example 1

TABLE 5

| | | Concentration | Concentration of |
|---|---|---|---|
| | Mass | of ingredients, | ingredients, |
| Ingredient | (kg) | with water | without water |
| Diglyceride | 3 | 2.7% | 22.7% |
| Acetyl triacylglycerol | 7 | 6.2% | 53.0% |
| Calcium salt of succinylated | 0.2 | 0.2% | 1.5% |
| diglyceride | | | |
| Powdered mustard (Sinapisalba) | 3 | 2.7% | 22.7% |
| Water | 100 | 88% | — |

An example of a coating of the inventive subject matter is disclosed in Table 5. The coating was created using a diglyceride, an acetyl triacylglycerol, a calcium salt of succinylated diglyceride, an antiseptic, and water. To create the coating, 3 kg of diglyceride, 7 kg of acetyl triglyceride, and 0.2 kg of calcium salt of succinylated diglyceride were mixed and heated until the mixture melted. 100 kg of water was then added to the melted mixture and stirred vigorously until an emulsion formed. Mixing was carried out in a container with a mixer having a rotating element operating in the 700-800 rpm range. Once mixed, 3 kg of powdered mustard (Sinapisalba) was mixed into the emulsion as an antiseptic. This yielded 113.2 kg of a coating of the inventive subject matter, where the coating had a white color and had no smell or taste. Although 100 kg of water was added in this embodiment, the amount of water relative to the other ingredients of the coating can vary according to disclosure included above. This is true for all examples described below, as well.

In this example, the coating was applied to Pink Lady apples. The coating was applied to the apples by placing the apples on a net-shaped conveyor, which passed them through a tub filled with the coating. The conveyor caused the apples to be submerged in the coating for, e.g., 60-90 seconds. Once the apples emerged from the tub, excess coating was allowed to drip off, and the apples were allowed to dry. This treatment created a thin peel on the surface of the apples. 1000 kg of apples having the coating applied were then placed in storage at a temperature of 0±1° C. and a humidity of 90-95%.

Simultaneously, 1000 kg of uncoated control apples were placed into the same storage area. All apples were stored for 9 months. After 9 months, 197 kg (19.7%) of apples treated with the coating had spoiled, while 466 kg (46.6%) of control apples had spoiled. Unspoiled apples that had been treated with the coating retained their original shape, color, and aroma.

In another test of this same coating, 500 kg of melon gourds were submerged in the coating for 60-90 seconds. After being taken out of the coating, the melon gourds were left in the air for 3 to 5 minutes to allow excess coating to drain off and to dry. The melon gourds were placed in storage at a temperature of 0±1° C. Simultaneously, 150 kg of uncoated control melon gourds were placed into the same storage area. At the end of 18 days in storage, 22 kg (4.4%) of melon gourds with the coating spoiled while 14.7 kg (9.8%) of the uncoated control melon gourds spoiled.

### Example 2

TABLE 5

| | | | |
|---|---|---|---|
| | | Concentration | Concentration of |
| | Mass | of ingredients, | ingredients, |
| Ingredient | (kg) | with water | without water |

| | | | |
|---|---|---|---|
| Diglyceride | 0.8 | 0.7% | 26.2% |
| Acetyl triacylglycerol | 1.7 | 1.5% | 55.7% |
| Calcium salt of succinylated | 0.05 | 0.0% | 1.6% |
| diglyceride | | | |
| Powdered mustard (Sinapisalba) | 0.5 | 0.4% | 16.4% |
| Water | 100 | 88% | — |

Another example of a coating of the inventive subject matter is disclosed in Table 5. The coating was created by starting with 0.8 kg diglyceride, 1.7 kg acetyl triglyceride, 0.05 kg magnesium salt of lactylated diglyceride, all of which were mixed and heated until the mixture melted. 100 kg of water was then mixed into the melted mixture to create an emulsion. Next, 0.5 kg of horseradish (Armoracia) root extract was mixed into the emulsion, yielding a coating having a mass of 104.1 kg.

This coating was then used to treat Anna apples. The apples were treated with the coating in a manner similar to that described in Example 1, above. 1000 kg of apples that were treated with the coating were placed in storage. At the same time, 1000 kg of uncoated control apples of the same variety placed into the same storage area. All apples were stored for 9 months. 133 kg (13.3%) of the coated apples spoiled, while 426 kg (42.6%) of the uncoated apples spoiled.

This same coating was also tested with tomatoes. 200 kg of tomatoes were submerged in the coating for 1-1.5 minutes. After that duration of time had elapsed, the tomatoes were removed from the coating and allowed to air dry for 3 to 5 minutes to allow the excess coating to drip off the tomatoes. The tomatoes were stored according to the same storage conditions as the apples (in storage rooms at a temperature of 0±1° C. and a humidity of 85 to 90%). Simultaneously, 200 kg of uncoated control tomatoes were also placed into storage. All tomatoes were stored for 28 days. At the end of 28 days, tomato waste among the coated tomatoes was 15.8 kg (7.9%) for the coated tomatoes and 39 kg (19.5%) for the control tomatoes.

In another test of this coating formulation, 100 kg of onions were submerged for 1-1.5 minutes in the coating. After being removed from submersion, the onions were then left in the air for 3 to 5 minutes to allow excess coating to drain off. The coated onions were then placed in storage at a temperature of 0±2° C. At the same time, 50 kg of uncoated control onions were placed in the same storage area. All onions were stored for 170 days. After that period of time, 8.9 kg (8.9%) of the coated onions ultimately spoiled, while 11.3 kg (22.6%) of the uncoated control onions spoiled.

In another test of this coating, 250 kg of black currants were submerged in the coating for 1-1.5 minutes. After being submerged, the black currants were allowed to air dry and for excess coating to drain off for 3 to 5 minutes. Coated black currants were then placed in storage at a temperature of 0±1° C. Simultaneously, 100 kg of uncoated control black currants were also placed into the same storage area. The black currants were all stored for 19 days. 17.25 kg (6.9%) of the coated black currants ultimately spoiled, while 16.9 kg (16.9%) of the control black currants spoiled.

### Example 3

TABLE 6

| | | Concentration | Concentration |
|---|---|---|---|
| | Mass | of ingredients, | of ingredients, |
| Ingredient | (kg) | with water | without water |
| Diglyceride | 6 | 4.8% | 24.7% |
| Acetyl triglyceride | 12 | 9.7% | 49.4% |
| Potassium salt of | 0.3 | 0.2% | 1.2% |
| lactylated | | | |
| diglyceride | | | |
| Antiseptic | 6 | 4.8% | 24.7% |
| Water | 100 | 80.5% | — |

Another example of a coating of the inventive subject matter is disclosed in Table 6. The coating was created by starting with 6 kg of diglyceride, 12 kg of acetyl triglyceride, and 0.3 kg of potassium salt of lactylated diglyceride. Those ingredients were mixed and heated until the mixture melted. 100 kg of water was then added to the melted mixture and mixed intensively until an emulsion formed. Next, 6 kg of mustard powder (Sinapisalba) was mixed into the emulsion to create the coating. 124.3 kg of coating resulted.

1000 kg of Golden Dorset apples were treated with the coating and placed into storage as described in Example 1, above. 1000 kg of uncoated control Golden Dorset apples were also placed into storage. All apples were stored for 9 months. 121 kg (12.1%) of apples having the coating spoiled, while 390 kg (39.0%) of control apples spoiled.

This coating was also tested on Winter Banana apples. 00 kg of Winter Banana apples were submerged in the coating for 60-90 seconds. After the coating was applied, the apples were taken out and left in the air for 3 to 5 minutes to allow excess coating to drain off. Then the apples were placed in storage rooms subject to the same conditions described in Example 1. At the same time, 100 kg of uncoated control Winter Banana apples were placed in storage. The apples were all stored for 16 days. 11.7 kg (3.9%) of apples treated with the coating spoiled, while 11 kg (11%) of the control apples spoiled.

This coating was also tested on gooseberries. 200 kg of gooseberries were submerged in the coating for 1-1.5 minutes, and at the end of that duration of time, they were taken out and allowed to dry and for excess coating to drain off for 3-5 minutes. The coated gooseberries were then placed in storage at a temperature of 0±1° C. Simultaneously, 50 kg of uncoated control gooseberries were placed into the same storage area. All gooseberries were stored for 20 days. 13.2 kg (6.6%) of the coated gooseberries spoiled, while 7.6 kg (15.2%) of the control gooseberries spoiled.

### Example 4

| | | Concentration | Concentration |
|---|---|---|---|
| | Mass | of ingredients, | of ingredients, |
| Ingredient | (kg) | with water | without water |
| Diglyceride | 2 | 1.8% | 23.0% |
| Acetyl triglyceride | 3.5 | 3.2% | 40.2% |
| Potassium salt of | 0.2 | 0.2% | 2.3% |
| lactylated | | | |
| diglyceride | | | |
| Antiseptic | 3 | 2.8% | 34.5% |
| Water | 100 | 92.0% | — |

Another example of a coating of the inventive subject matter is disclosed in Table 7. This coating was made starting with 2 kg of diglyceride, 3.5 kg of acetyl triglyceride, and 0.2 kg of ammonium salt of lactylated diglyceride. These ingredients were mixed and heated until the mixture melts. 100 kg of water was then added to the melted mixture and mixed intensively until an emulsion formed. Mixing the emulsion took place in a container with a mixer operating between 700-800 rpm. 3 kg of coriander seed (Coriandrum sativum) powder was then added to the emulsion and mixed again. This yielded 108.7 kg of coating.

As a test, the coating was applied to 1000 kg of Dalmena Green apples as described in Example 1, above. The coated apples were stored for 286 days at a temperature of 0±1° C. with a relative humidity of 90 to 95%, 1000 kg of control uncoated apples were also placed in storage. Of the coated apples, 206 kg (20.6%) apples ultimately spoiled, while among the control apples 467 kg (46.7%) spoiled.

### Example 5

| | | Concentration | Concentration |
|---|---|---|---|
| | Mass | of ingredients, | of ingredients, |
| Ingredient | (kg) | with water | without water |
| Diglyceride | 6 | 4.9% | 28.2% |
| Acetyl triglyceride | 9 | 7.4% | 42.3% |
| Potassium salt of | 0.3 | 0.2% | 1.4% |
| lactylated | | | |
| diglyceride | | | |
| Antiseptic | 6 | 4.9% | 28.2% |
| Water | 100 | 82.4% | — |

Another example of a coating of the inventive subject matter is disclosed in Table 8. This coating was made starting with 6 kg of diglyceride, 9 kg of acetyl triglyceride, and 0.3 kg of magnesium salt of succinylated diglyceride. These ingredients were mixed and heated until the mixture melted. 100 kg of water was then mixed intensively into the melted mixture until an emulsion formed. Mixing was carried out in a container with a mixer running at 700-800 rpm. 6 kg of onion (Allium) extract was then added into the emulsion and mixed again. This yielded 121.3 kg of coating.

To test, the coating was applied to 1000 kg Gloster apples as described in Example 1. The coated apples were kept at a temperature of 0±1° C. and relative humidity of 90% to 95% for 278 days. 1000 kg of uncoated control Gloster apples were put into the same storage area. Among the coated applies, 247 kg (24.7%) spoiled, while 503 kg (50.3%) of the control apples spoiled.

### Example 6

| | | Concentration | Concentration |
|---|---|---|---|
| | Mass | of ingredients, | of ingredients, |
| Ingredient | (kg) | with water | without water |
| Diglyceride | 4 | | 30.3% |
| Acetyl triglyceride | 6 | 5.3% | 45.5% |
| Potassium salt of | 0.3 | 0.3% | 2.3% |
| lactylated | | | |
| diglyceride | | | |
| Antiseptic | 2.9 | 2.6% | 22.0% |
| Water | 100 | 88.3% | — |

Another example of a coating of the inventive subject matter is disclosed in Table 9. This coating was made starting with 4 kg of diglyceride, 6 kg of acetyl triglyceride, and 0.3 kg of calcium salt of succinylated diglyceride. These ingredients were mixed and heated until the mixture melted. 100 kg of water was then intensively mixed into the melted mixture until an emulsion formed. Mixing was carried out in a container with a mixer at a speed of 700-800 rpm. Next, 2.9 kg Spanish pepper (Capsicum annuum) powder was added into the emulsion and it was mixed again.

This coating was tested using Anna apples. The coating was applied to 1000 kg of Anna apples as described in Example 1, above. The coated apples were stored at a temperature of 0±1° C. and relative humidity of 92 to 95% for 260 days. 1000 kg of uncoated control Anna apples were also stored in the same area. 223 kg (22.3%) of the coated apples ultimately spoiled, while 426 kg (42.6%) of the control apples spoiled.

### Example 7

| | | Concentration | Concentration |
|---|---|---|---|
| | Mass | of ingredients, | of ingredients, |
| Ingredient | (kg) | with water | without water |
| Diglyceride | 5 | 4.4% | 37.9% |
| Acetyl triglyceride | 7 | 6.2% | 53.0% |
| Potassium salt of | 0.4 | 0.4% | 3.0% |
| lactylated | | | |
| diglyceride | | | |
| Antiseptic | 3 | 2.7% | 22.7% |
| Water | 100 | 88.3% | — |

Another example of a coating of the inventive subject matter is disclosed in Table 10. This coating was made starting with 5 kg of diglyceride, 7 kg of acetyl triglyceride, and 0.4 kg of sodium salt of lactylated diglyceride. These ingredients were mixed and heated until the mixture melted. 100 kg of water was then intensively mixed into the melted mixture until an emulsion formed. Mixing was carried out in a container with a mixer at a speed of 700-800 rpm. Next, 3 kg garlic extract (Allium sativum) was added into the emulsion and it was mixed again.

This coating was tested on James Drif apples. 1000 kg of James Drif apples were treated with the coating as described in Example 1. The coated apples were then stored at a temperature of 0±1° C. and relative humidity of 90 to 95% for 300 days. 1000 kg of uncoated control James Drif apples were also stored. 231 kg (23.1%) of the coated apples ultimately spoiled, while 498 kg (49.8%) of the control apples spoiled.

Thus, specific compositions and methods of food preserving coatings have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

1. A food preserving coating formulation, comprising:
a diglyceride;
an acetyl triacylglycerol, wherein the acetyl triacylalycerol is an oil derived from at least one of a Gymnosporia seneqalensis plant, a Loeseneriella africana plant, Mystroxylon aethiopicum, and a Cassine burkeana plant;
an emulsifier;
an antiseptic; and
water.

2. The formulation of claim 1, wherein the diglyceride comprises at least one of a palmitic acid, a stearic acid, and oleic acid, and a linoleic acid.

3. The formulation of claim 1, wherein the antiseptic comprises a byproduct of a member of the genus Allium.

4. The formulation of claim 1, wherein the antiseptic comprises a garlic byproduct.

5. The formulation of claim 1, wherein the antiseptic comprises blackjack.

6. (canceled)

7. The formulation of claim 1, wherein the acetyl triacylglycerol is an oil derived from at least one of a plant belonging to the Celastraceae family.

8. The formulation of claim 1, wherein the diglyceride has a concentration relative to non-water ingredients in a range of 19-30%.

9. The formulation of claim 1, wherein the acetyl triacylglycerole has a concentration relative to non-water ingredients of 40-65%.

10. The formulation of claim 1, wherein the emulsifier has a concentration relative to non-water ingredients of 14-35%.

11. The formulation of claim 1, wherein the water has a concentration of 70-97%.

12. A food preserving coating formulation, comprising:
a diglyceride;
an acetyl triacylglycerol comprising a plant oil, wherein the plant oil comprises at least one of a Gymnosporia seneqalensis plant, a Loeseneriella africana plant, Mystroxylon aethiopicum, and a Cassine burkeana plant;
an emulsifier comprising at least one of a lactyl diglyceride salt and a succinylated diglyceride salt;
an antiseptic; and
water.

13. The formulation of claim 12, wherein the diglyceride comprises at least one of a palmitic acid, a stearic acid, and oleic acid, and a linoleic acid.

14. The formulation of claim 12, wherein the antiseptic comprises blackjack.

15. The formulation of claim 12, wherein the diglyceride has a concentration relative to non-water ingredients of 19-30%.

16. The formulation of claim 12, wherein the acetyl triacylglycerole has a concentration relative to non-water ingredients of 40-65%.

17. The formulation of claim 12, wherein the emulsifier has a concentration relative to non-water ingredients of 14-35%.

18. The formulation of claim 12, wherein the water has a concentration of 70-97%.

19. (canceled)

20. (canceled)
